(19) United States
(12) Patent Application Publication
(10) Pub. No.: US 2007/0121719 A1
(43) Pub. Date: May 31, 2007

(54) System and method for combining advanced data partitioning and fine granularity scalability for efficient spatiotemporal-snr scalability video coding and streaming

(75) Inventors: Mihaela Van Der Schaar, Sacremento, CA (US); Yingwei Chen, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICSS N.V., EINDHOVEN (NL)

(21) Appl. No.: 10/573,747

(22) PCT Filed: Sep. 27, 2004
(86) PCT No.: PCT/IB04/51885

§ 371 Date: Mar. 28, 2006

Related U.S. Application Data
(60) Provisional application No. 60/506,885, filed on Sep. 29, 2003.

(51) Int. Cl. H04B 1/66; H04N 7/12

(52) U.S. Cl. 375/240.1; 375/240.26

(57) ABSTRACT

A system and method is provided for combining advanced data partitioning and fine granularity scalability in the transmission of digital video signals. A partition unit 440 located in a base layer encoding unit 410 of a video encoder 400 partitions a base layer bit stream 310, 320 into a base layer first partition bit stream 310 and a base layer second partition bit stream 320. Each of the two base layer bit streams 310, 320 may be output directly or may be encoded before output. The two base layer bit streams 310, 320 may be encoded with a scalable encoder unit 442 or with a non-scalable encoder unit 444. Fine granularity scalability is improved by providing an extended base layer bit rate. The bit rate range for advanced data partitioning is also extended. The invention provides improved video coding efficiency, complexity scalability, and spatial scalability.

The present invention is directed, in general, to digital signal transmission systems and, more specifically, to a system and method for combining advanced data partitioning and fine granularity scalability in the transmission of digital video signals.

Advanced data partitioning (ADP) in digital video encoding is advantageous because it provides graceful degradation under small to moderate variations in channel conditions. Advanced data partitioning has only a very limited coding penalty compared to non-scalable coding. Fine granularity scalability (FGS) can also provide graceful degradation and bandwidth adaptability over large variations in channel conditions. However, fine granularity scalability incurs a considerable coding penalty when bandwidth ranges are large.

The presently existing fine granularity scalability (FGS) framework provides spatio-temporal-SNR scalability with fine-granularity over a large range of bit rates. The performance of FGS suffers a significant coding penalty when compared to non-scalable video coding techniques when the base layer bit rate is low and the coded video sequence exhibits a large temporal correlation. Research has established that the performance of FGS can be considerably improved if the base layer bit rate is increased at the expense of covering a lower bit rate range. Alternatively, the performance of advanced data partitioning (ADP) is very efficient when the bit rate variations are limited.

There is therefore a need in the art for a system and method that is capable of providing the benefits of both FGS and ADP in the transmission of digital video signals.

To address the deficiencies of the prior art mentioned above, the system and method of the present invention combines both advanced data partitioning (ADP) and fine granularity scalability (FGS) in the transmission of digital video signals. The present invention provides a unique and novel spatio-temporal-SNR scalable framework that combines the advantages of ADP and FGS. The present invention is thereby capable of achieving higher coding efficiency and improved spatial scalability than that achievable by ADP or than that achievable by FGS.

The system and method of the present invention comprises a partition unit that is located in a base layer encoding unit of a video encoder. The partition unit partitions a base layer bit stream into a base layer first partition bit stream and one or more base layer additional partition bit streams. The base layer first partition bit stream and the base layer additional partition bit streams may be output directly or may be encoded before output. The base layer first partition bit stream and the base layer additional partition bit streams may be encoded with a scalable encoder unit or with a non-scalable encoder unit.

Throughout the rest of this document, the case where the base layer is partitioned into two base layer partition bit streams will be used. Those who are skilled in the field will be able to extend the invention description to the general case where more than two base layer partition bit streams may be generated.

Fine granularity scalability is improved by providing an extended base layer bit rate. The bit rate range for the advanced data partitioning is also extended. The present invention provides improved video coding efficiency, complexity scalability, and spatial scalability.

In one advantageous embodiment of the system and method of the present invention, a FGS transcoder transcodes a single layer bit stream into a base layer bit stream having a base layer bit rate R_{B} and an enhancement layer bit stream having an enhancement layer bit rate R_{E}. A variable length encoder decodes variable length codes in the base layer bit stream. A variable length codes buffer uses the variable length codes to partition the base layer bit stream into a base layer first partition bit stream and a base layer second partition bit stream. A partitioning point finding unit provides an optimal partition point for partitioning the base layer bit stream.

It is an object of the present invention to provide a system and method for combining both advanced data partitioning (ADP) and fine granularity scalability (FGS) in the encoding and transmission of digital video signals.

It is another object of the present invention to provide a system and method combining ADP and FGS techniques to provide improvement in video coding efficiency.

It is also an object of the present invention to provide a system and method combining ADP and FGS techniques to provide improvement in complexity scalability.

It is another object of the present invention to provide a system and method combining ADP and FGS techniques to provide improvement in spatial scalability.

It is also an object of the present invention to provide a system and method for selecting an optimal bit rate for a base layer first partition of the invention.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

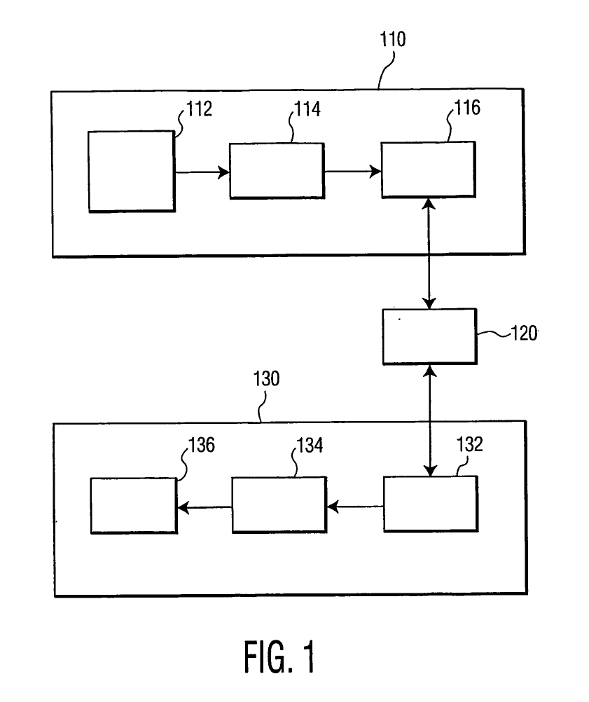

FIG. 1 is a block diagram illustrating an end-to-end transmission of streaming video from a streaming video transmitter through a data network to a streaming video receiver according to an advantageous embodiment of the present invention;

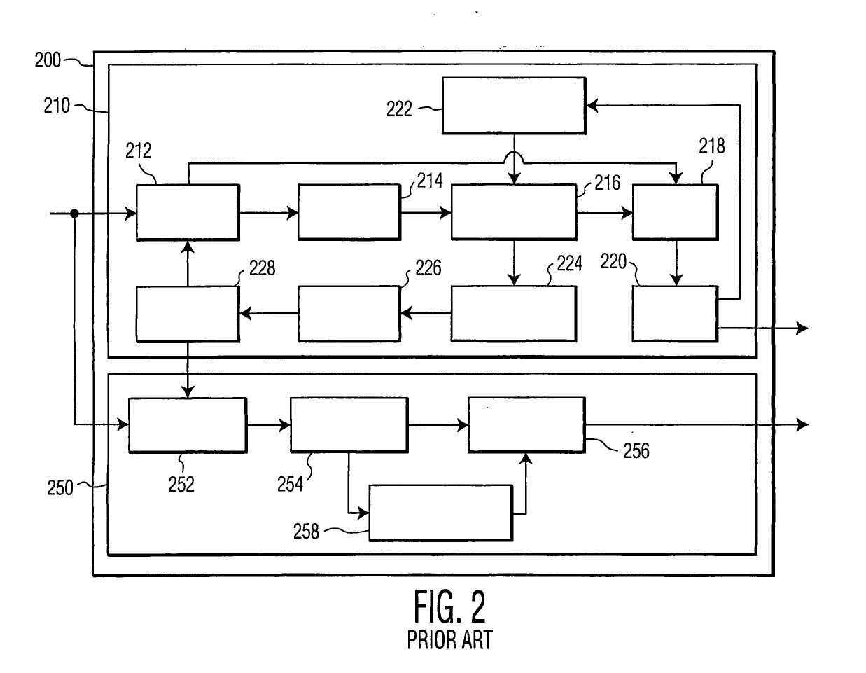

FIG. 2 is a block diagram illustrating an exemplary video encoder according to an embodiment of the prior art;

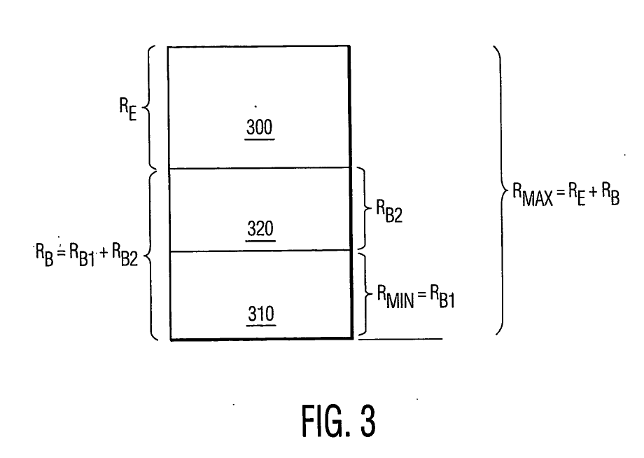

FIG. 3 is a diagram illustrating how a base layer bit stream may be partitioned into two bit stream partitions according to an advantageous embodiment of the present invention;

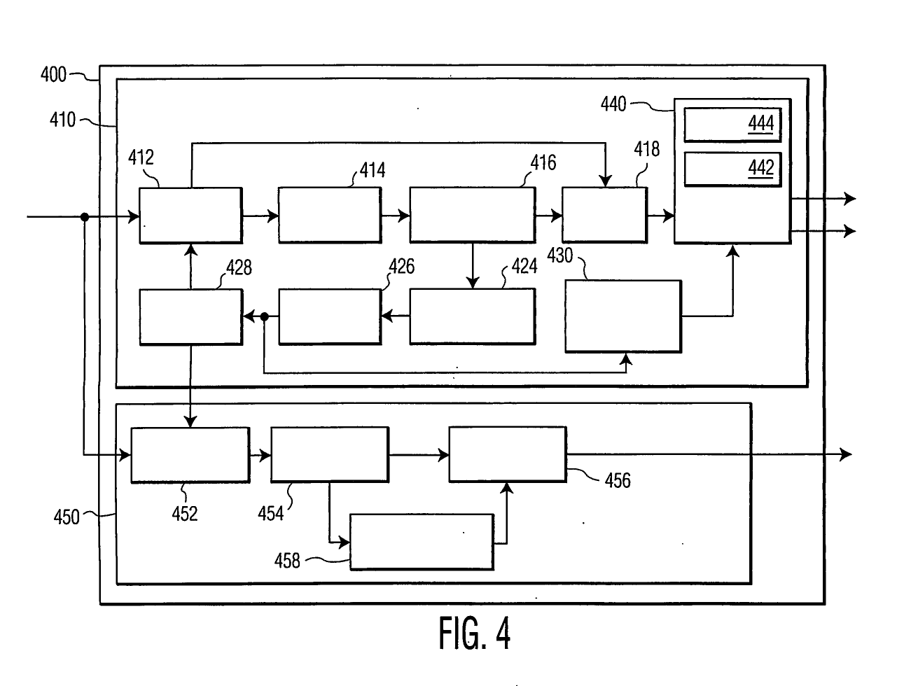

FIG. 4 is a block diagram illustrating an exemplary video encoder according to an advantageous embodiment of the present invention;

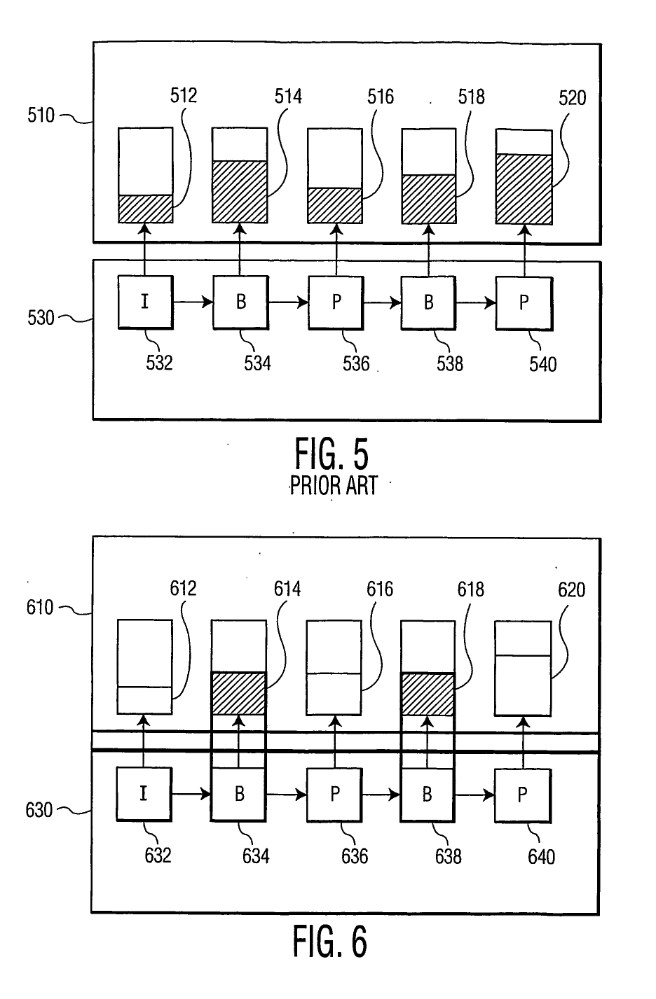

FIG. 5 illustrates an exemplary prior art sequence of an FGS encoded structure showing how encoded video frames are transmitted in an FGS enhancement layer;

FIG. 6 illustrates a sequence of a combination of an ADP and FGS encoded structure showing how encoded video frames are transmitted in accordance with an advantageous embodiment of the present invention;

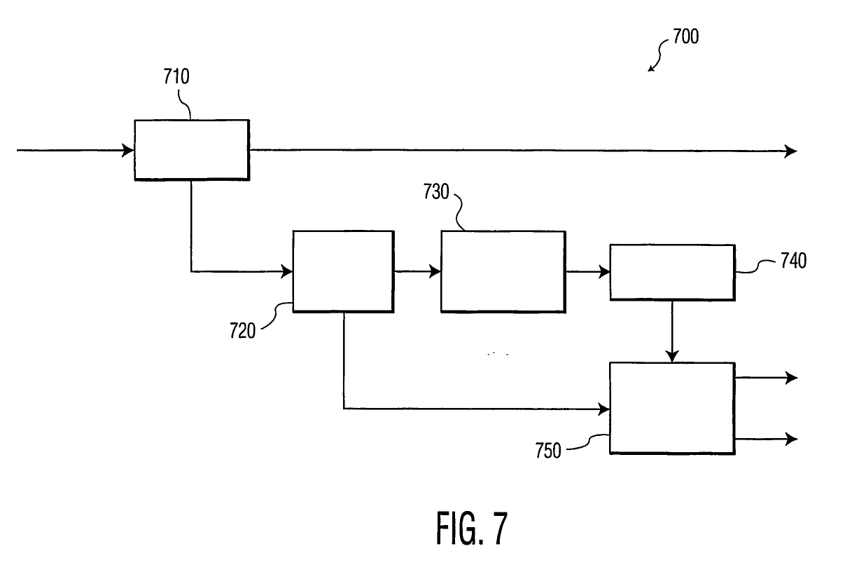

FIG. 7 is a block diagram illustrating an exemplary apparatus for creating the base layer partitions according to an alternate advantageous embodiment of the present invention;

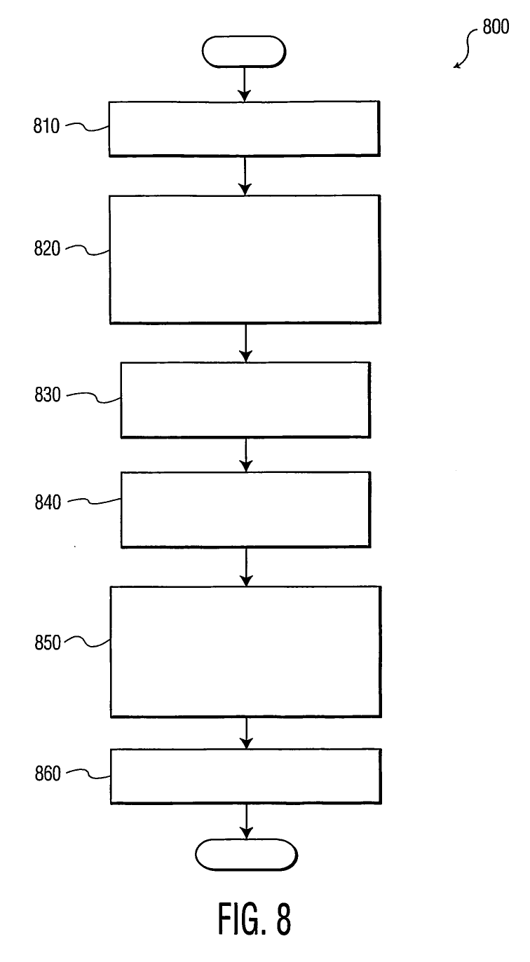

FIG. 8 illustrates a flowchart showing the steps of a first method of an advantageous embodiment of the present invention;

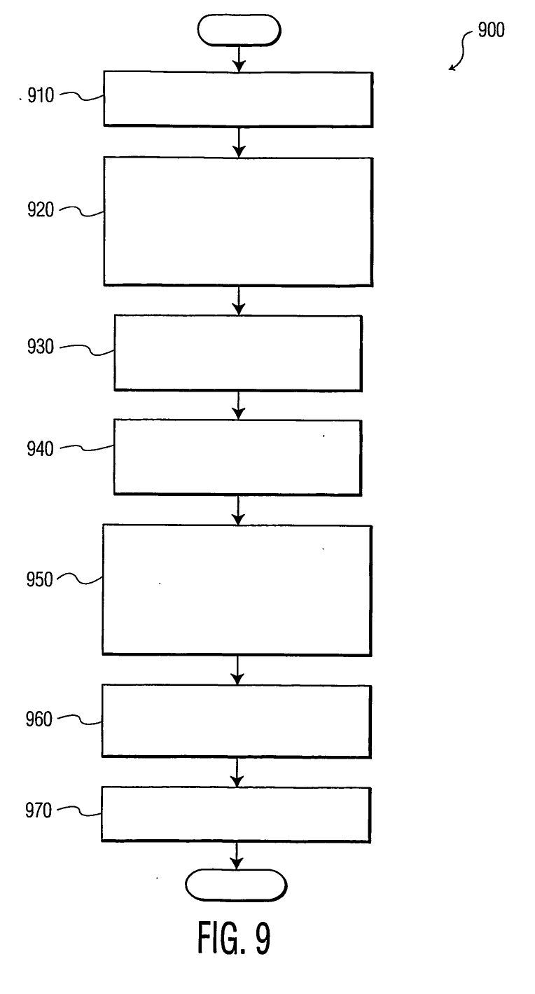

FIG. 9 illustrates a flowchart showing the steps of a second method of an advantageous embodiment of the present invention;

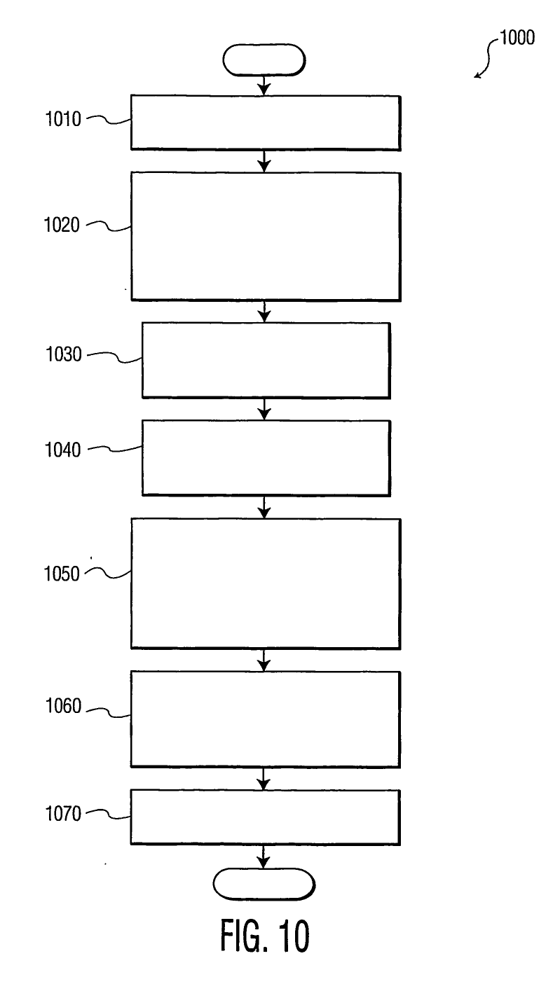

FIG. 10 illustrates a flowchart showing the steps of a third method of an advantageous embodiment of the present invention;

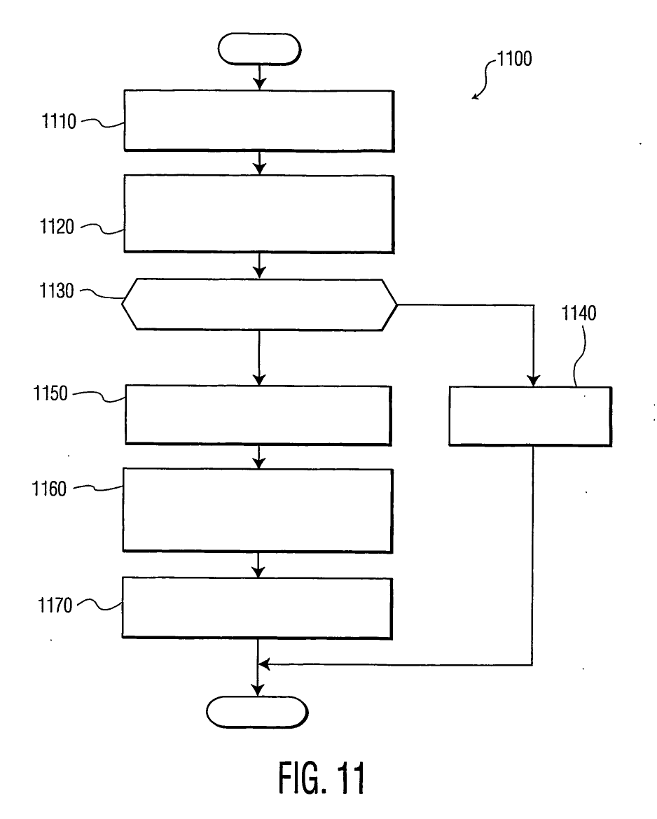

FIG. 11 illustrates a flowchart showing the steps of an advantageous method of the present invention for determining an optimal bit rate;

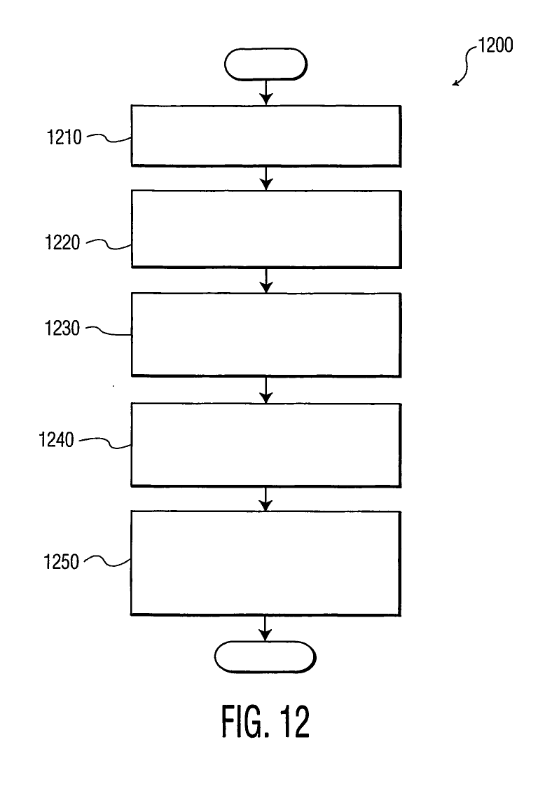

FIG. 12 illustrates a flowchart showing the steps of a fourth method of an advantageous embodiment of the present invention;

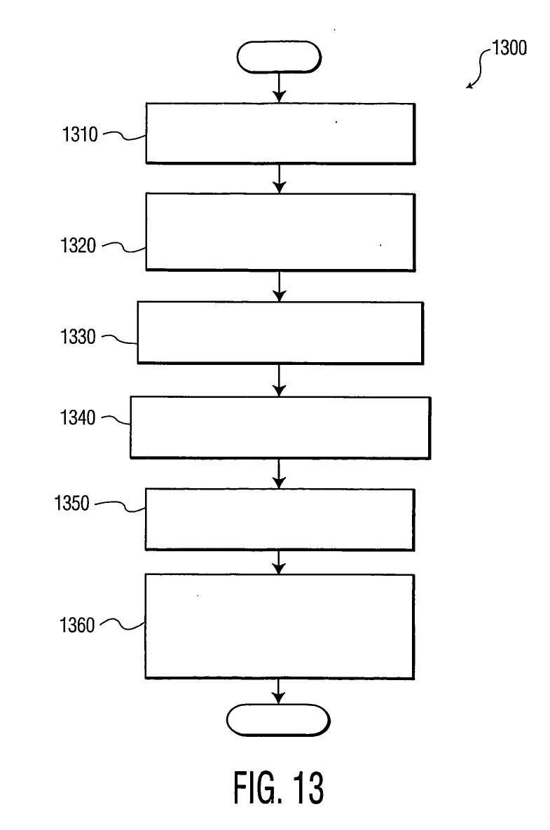

FIG. 13 illustrates a flowchart showing the steps of a fifth method of an advantageous embodiment of the present invention; and

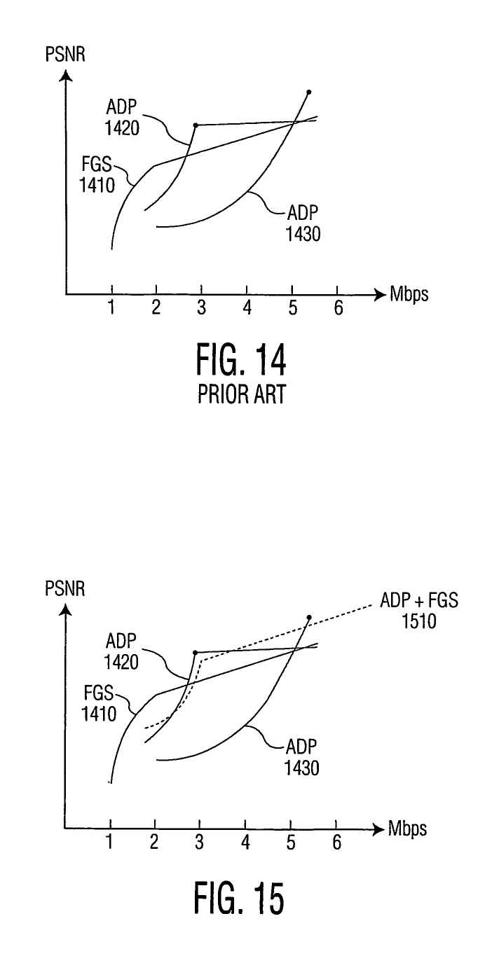

FIG. 14 illustrates a graph that displays the performance of a prior art FGS coded bit stream and two prior art ADP coded bit streams in terms of peak signal to noise ratio at different bit rates;

FIG. 15 illustrates a graph that displays the performance of an ADP+FGS coded bit stream of the present invention in terms of peak signal to noise ratio at different bit rates; and

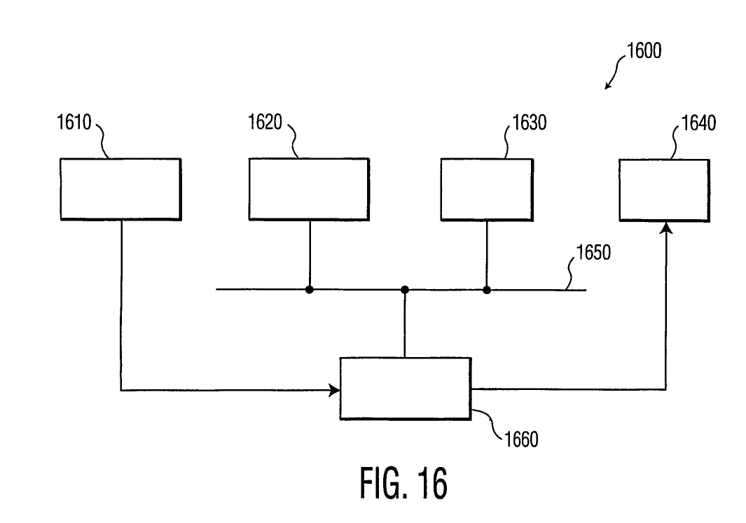

FIG. 16 illustrates an exemplary embodiment of a digital transmission system that may be used to implement the principles of the present invention.

FIGS. 1 through 16, discussed below, and the various embodiments used to describe the principles of the present invention in this patent document are by way of illustration only and should not be construed in any way to limit the scope of the invention. The present invention may be used in any digital video signal encoder or transcoder.

FIG. 1 is a block diagram illustrating an end-to-end transmission of streaming video from streaming video transmitter 110, through data network 120 to streaming video receiver 130, according to an advantageous embodiment of the present invention. Depending on the application, streaming video transmitter 110 may be any one of a wide variety of sources of video frames, including a data network server, a television station, a cable network, a desktop personal computer (PC), or the like.

Streaming video transmitter 110 comprises video frame source 112, video encoder 114 and encoder buffer 116. Video frame source 112 may be any device capable of generating a sequence of uncompressed video frames, including a television antenna and receiver unit, a video cassette player, a video camera, a disk storage device capable of storing a “raw” video clip, and the like. The uncompressed video frames enter video encoder 114 at a given picture rate (or “streaming rate”) and are compressed according to any known compression algorithm or device, such as an MPEG-4 encoder. Video encoder 114 then transmits the compressed video frames to encoder buffer 116 for buffering in preparation for transmission across data network 120. Data network 120 may be any suitable IP network and may include portions of both public data networks, such as the Internet, and private data networks, such as an enterprise owned local area network (LAN) or wide area network (WAN).

Streaming video receiver 130 comprises decoder buffer 132, video decoder 134 and video display 136. Decoder buffer 132 receives and stores streaming compressed video frames from data network 120. Decoder buffer 132 then transmits the compressed video frames to video decoder 134 as required. Video decoder 134 decompresses the video frames at the same rate (ideally) at which the video frames were compressed by video encoder 114. Video decoder 134 sends the decompressed frames to video display 136 for play-back on the screen of video display 136.

FIG. 2 is a block diagram illustrating an exemplary prior art video encoder 200. Video encoder 200 comprises base layer encoding unit 210 and enhancement layer encoding unit 250. Video encoder 200 receives an original video signal that is transferred to base layer encoding unit 210 for generation of a base layer bit stream and to enhancement layer encoding unit 250 for generation of an enhancement layer bit stream.

Base layer encoding unit 210 contains a main processing branch, comprising motion estimator 212, transform circuit 214, quantization circuit 216, entropy coder 218, and buffer 220, that generates the base layer bit stream. Base layer encoding unit 210 comprises base layer rate allocator 222, which is used to adjust the quantization factor of base layer encoding unit 210. Base layer encoding unit 210 also contains a feedback branch comprising inverse quantization circuit 224, inverse transform circuit 226, and frame store 228.

Motion estimator 212 receives the original video signal and estimates the amount of motion between a reference frame and the present video frame as represented by changes in pixel characteristics. For example, the MPEG standard specifies that motion information may be represented by one to four spatial motion vectors per sixteen by sixteen (16×16) sub-block of the frame. Transform circuit 214 receives the resultant motion difference estimate output from motion estimator 212 and transforms it from a spatial domain to a frequency domain using known de-correlation techniques, such as the discrete cosine transform (DCT).

Quantization circuit 216 receives the DCT coefficient outputs from transform circuit 214 and a scaling factor from base layer rate allocator circuit 222 and further compresses the motion compensation prediction information using well-known quantization techniques. Quantization circuit 216 utilizes the scaling factor from base layer rate allocator circuit 222 to determine the division factor to be applied for quantization of the transform output. Next, entropy coder 218 receives the quantized DCT coefficients from quantization circuit 216 and further compresses the data using variable length coding techniques that represent areas with a high probability of occurrence with a relatively short code and that represent areas of low probability of occurrence with a relatively long code.

Buffer 220 receives the output of entropy coder 218 and provides necessary buffering for output of the compressed base layer bit stream. In addition, buffer 220 provides a feedback signal as a reference input for base layer rate allocator 222. Base layer rate allocator 222 receives the feedback signal from buffer 220 and uses it in determining the division factor supplied to quantization circuit 216.

Inverse quantization circuit 224 de-quantizes the output of quantization circuit 216 to produce a signal that is representative of the transform input to quantization circuit 216. Inverse transform circuit 226 decodes the output of inverse quantization circuit 224 to produce a signal which provides a frame representation of the original video signal as modified by the transform and quantization processes. Frame store circuit 228 receives the decoded representative frame from inverse transform circuit 226 and stores the frame as a reference output to motion estimator circuit 212 and enhancement layer encoding unit 250. Motion estimator circuit 212 uses the resultant stored frame signal as the input reference signal for determining motion changes in the original video signal.

Enhancement layer encoding unit 250 contains a main processing branch, comprising residual calculator 252, transform circuit 254, and fine granular scalability (FGS) encoder 256. Enhancement layer encoding unit 250 also comprises enhancement rate allocator 258. Residual calculator 252 receives frames from the original video signal and compares them with the decoded (or reconstructed) base layer frames in frame store 228 to produce a residual signal representing image information which is missing in the base layer frames as a result of the transform and quantization processes. The output of residual calculator 252 is known as the residual data or residual error data.

Transform circuit 254 receives the output from residual calculator 252 and compresses this data using a known transform technique, such as DCT. Though DCT serves as the exemplary transform for this implementation, transform circuit 254 is not required to have the same transform process as base layer transform 214.

FGS frame encoder circuit 256 receives outputs from transform circuit 254 and enhancement rate allocator 258. FGS frame encoder circuit 256 encodes and compresses the DCT coefficients as adjusted by enhancement rate allocator 258 to produce the compressed output for the enhancement layer bit stream. Enhancement rate allocator 258 receives the DCT coefficients from transform circuit 254 and utilizes them to produce a rate allocation control that is applied to FGS frame encoder circuit 256.

The prior art implementation depicted in FIG. 2 results in an enhancement layer residual compressed signal that is representative of the difference between the original video signal and the decoded base layer data

The present invention combines advanced data partitioning (ADP) with fine granularity scalability (FGS) in order to achieve improved coding efficiency, improved complexity scalability and improved spatial scalability. There are multiple ways to combine ADP and FGS. A first application of the combination of ADP and FGS will be described with reference to texture coding. In the description of the first method of the invention the base layer is divided into two partitions. Each partition is assigned a particular bit rate.

FIG. 3 illustrates the relationship between the bit rates for enhancement layer 300 and base layer first partition 310 and base layer second partition 320. The bit rate for enhancement layer 300 is designated R_{E}. The bit rate for base layer first partition 310 is designated R_{B1}. Bit rate R_{B1} is equal to the minimum bit rate R_{MIN}. The bit rate for base layer second partition 320 is designated R_{B2}. Total bit rate for the base layer is designated R_{B}. The bit rate R_{B} is the sum of the bit rates R_{B1} and R_{B2}. The total bit rate for the enhancement layer and the base layer is designated R_{MAX}. The bit rate R_{MAX} is the sum of the bit rates R_{E} and R_{B}. Although the method of the present invention is described with two base layer partitions, it is understood that in other embodiments of the invention the base layer may be partitioned into more than two partitions.

The present invention provides an apparatus and method for encoding the two partitions of the base layer. In ADP, the two partitions of the base layer are generated by splitting variable length codes (VLC) from a non-scalable bit stream (e.g., MPEG-2 or MPEG-4) without recoding. In the present invention (i.e., the combination of ADP and FGS) the concept of partitioning is generalized to include not only the splitting of variable length codes (VLC) but to also include recoding. Therefore, both partitions of the base layer can be encoded (or recoded) using (1) non-scalable coders such as MPEG-2 and MPEG-4 coders, and (2) scalable coders such as FGS coders.

FIG. 4 is a block diagram illustrating an exemplary video encoder 400 in accordance with the principles of the present invention. Except for the features of the present invention, video encoder 400 is similar in construction and operation to prior art video encoder 200. Video encoder 400 comprises base layer encoding unit 410 and enhancement layer encoding unit 450. Video encoder 400 receives an original video signal that is transferred to base layer encoding unit 410 for generation of a base layer bit stream and to enhancement layer encoding unit 450 for generation of an enhancement layer bit stream.

Enhancement layer encoding unit 450 of FIG. 4 operates in the same manner as prior art enhancement layer encoding unit 250 of FIG. 2. Residual calculator 452, transform circuit 454, FGS frame encoder 456, and enhancement rate allocator 458 of enhancement layer coding unit 450 operate in the same manner, respectively, as residual calculator 252, transform circuit 254, FGS frame encoder 256, and enhancement rate allocator 258 of prior art enhancement layer coding unit 250.

Similarly, many of the elements of base layer encoding unit 410 operate in the same manner as their respective counterparts in prior art base layer encoding unit 210. Motion estimator 412, transform circuit 414, quantization circuit 416, entropy coder 418, inverse quantization circuit 424, inverse transform circuit 426, and frame store 428 operate in the same manner, respectively, as motion estimator 212, transform circuit 214, quantization circuit 216, entropy coder 218, inverse quantization circuit 224, inverse transform circuit 226, and frame store 228 of prior art base layer coding unit 210.

In order to more clearly show the elements of the present invention within base layer encoding unit 410, a buffer that is the counterpart of buffer 220 has not been shown in FIG. 4. Similarly, a base-layer allocation unit that is the counterpart of base-layer rate allocation unit 222 has not been shown in FIG. 4. The buffer (not shown) and the base-layer rate allocation unit (not shown) are present in base layer encoding unit 410 and perform the same function as their counterparts in prior art base layer encoding unit 210.

Base layer encoding unit 410 of the present invention comprises partition point calculation unit 430 and partition unit 440. Partition point calculation unit 430 receives a signal from the output of inverse transform unit 426 and uses the signal to calculate a partition point for the base layer. That is, partition point calculation unit 430 determines how to allocate the base layer bit rates (R_{B1} and R_{B2}) between base layer first partition 310 and base layer second partition 320. In an advantageous embodiment of the invention, the two base layer bit rates are equal. When bit rate B_{R1} and bit rate B_{R2} are equal, the base layer first partition 310 and base layer second partition 320 operate at the same bit rate.

Partition point calculation unit 430 is capable of determining the optimal partition point for partitioning the base layer into two partitions. The optimal partition point can be determined using the technique that is more fully described in a paper by Jong Chul Ye and Yingwei Chen entitled “Rate Distortion Optimized Data Partitioning for Single Layer Video” (currently submitted for publication), which is incorporated herein by reference for all purposes.

Partition point calculation unit 430 provides the partition point information to partition unit 440. Partition unit 440 uses the partition point information to partition the base layer bit stream into base layer first partition 310 bit stream and base layer second partition 320 bit stream.

Partition unit 440 also comprises a scalable coder 442 and a non-scalable coder 444. Partition unit 440 may use either scalable coder 442 or non-scalable coder 444 to scale base layer first partition bit stream 310 or base layer second partition bit stream 320.

FIG. 5 illustrates an exemplary prior art sequence of an FGS encoded structure showing how encoded video frames are transmitted in an FGS enhancement layer. As shown in FIG. 5, encoded video frames 512, 514, 516, 518 and 520 of enhancement layer 510 are transmitted concurrently with the base layer encoded frames 532, 534, 536, 538 and 540 of base layer 530. This arrangement provides a high quality video image because the FGS enhancement layer 510 frames supplement the encoded data in the corresponding base layer 530 frames.

FIG. 6 illustrates a sequence of a combination of an ADP and FGS encoded structure showing how encoded video frames are transmitted in accordance with an advantageous embodiment of the present invention. As shown in FIG. 6, encoded video frames 612, 614, 616, 618 and 620 of enhancement layer 610 are transmitted concurrently with the base layer encoded frames 632, 634, 636, 638 and 640 of base layer 630. The dark line that encloses encoded video frame 634 in base layer 630 and encoded video frame 614 in enhancement layer 610 represents an extended base layer that includes both base layer first partition 310 and base layer second partition 320. Similarly, the dark line that encloses encoded video frame 638 in base layer 630 and encoded video frame 618 in enhancement layer 610 represents an extended base layer that includes both base layer first partition 310 and base layer second partition 320.

The ADP encoded frames or the FGS encoded frames can be included in all frame types (i.e., I frames, P frames, B frames) or only in some frames (e.g., I frames and P frames), as shown in FIG. 6. Different combinations of ADP and FGS are possible for different types of frames.

FIG. 7 is a block diagram illustrating an exemplary apparatus 700 for creating the base layer partitions according to an alternate advantageous embodiment of the present invention. In this embodiment FGS transcoder 710 receives a single layer bit stream. FGS transcoder 710 transcodes the single layer bit stream into an FGS bit stream having a base layer bit rate R_{B} and into an enhancement layer bit stream having an enhancement layer bit rate R_{E}. FGS transcoder 710 outputs the enhancement layer bit stream with bit rate R_{E}. FGS transcoder 710 also sends the base layer bit stream with bit rate R_{B} to variable length decoder 720.

Variable length decoder 720 sends the base layer bit stream to inverse scan/quantization unit 730. Inverse scan/quantization unit 730 outputs discrete cosine transform (DCT) coefficients to partitioning point finder unit 740. Partitioning point finder unit 740 calculates the optimal partition point for dividing the base layer bit stream into the two base layer partitions. Partitioning point finder unit 740 then sends the partition point information to variable length codes buffer 750.

Variable length decoder 720 is also coupled to variable length codes buffer 750. Variable length decoder 720 decodes the variable length codes (VLC) and provides the VLC codes to variable length codes buffer 750. Variable length codes buffer 750 uses the input of the VLC codes from variable length decoder 720 and the partition point information from partitioning point finder 740 to determine and output the base layer first partition bit stream and the base layer second partition bit stream.

A first method of an advantageous embodiment of the present invention will now be described. A single layer coded bit stream is input to an FGS transcoder. The FGS transcoder transcodes the single layer bit stream into an FGS enhancement layer bit stream having an enhancement layer bit rate of R_{E} and into a base layer bit stream having a base layer bit rate of R_{B}. A determination is made that the base layer first partition bit stream has non-scalable texture coding. A determination is also made that the base layer second partition bit stream has non-scalable texture coding.

The base layer bit stream is then partitioned into a base layer first partition bit stream having a bit rate of R_{B1} and into a base layer second partition bit stream having a bit rate of R_{B2}. The base layer first partition bit stream and the base layer second partition bit stream are not recoded. The base layer first partition bit stream and the base layer second partition bit stream are then provided as output along with the FGS enhancement layer bit stream. This provides an ADP+FGS bit stream in accordance with the principles of the invention.

When the input video signal is an uncompressed video, the input video signal is first encoded into an FGS bit stream having an enhancement layer bit rate of R_{E} and having a base layer bit rate of R_{B}. The remaining steps of the first method described above are then carried out.

FIG. 8 illustrates a flowchart showing the steps of a first method of an advantageous embodiment of the present invention described above. In the first step a single layer coded bit stream is received in an FGS transcoder (step 810). The FGS transcoder transcodes the single layer bit stream into an FGS enhancement layer bit stream having an enhancement layer bit rate of R_{E} and into a base layer bit stream having a base layer bit rate of R_{B} (step 820). The base layer first partition bit stream is determined to have non-scalable texture coding (step 830). The base layer second partition bit stream is also determined to have non-scalable texture coding (step 840). The base layer bit stream is then partitioned into a base layer first partition bit stream having a bit rate of R_{B1} and into a base layer second partition bit stream having a bit rate of R_{B2} (step 850). The base layer first partition bit stream and the base layer second partition bit stream are then provided as output along with the FGS enhancement layer bit stream (step 860).

A second method of an advantageous embodiment of the present invention will now be described. In the second method base layer first partition bit stream has non-scalable texture coding and the base layer second partition bit stream has scalable texture coding. A single layer coded bit stream is input to an FGS transcoder. The FGS transcoder transcodes the single layer bit stream into an FGS enhancement layer bit stream having an enhancement layer bit rate of R_{E} and into a base layer bit stream having a base layer bit rate of R_{B}. A determination is made that the base layer first partition bit stream has non-scalable texture coding. A determination is also made that the base layer second partition bit stream has scalable texture coding.

The base layer bit stream is then partitioned into a base layer first partition bit stream having a bit rate of R_{B1} and into a base layer second partition bit stream having a bit rate of R_{B2}. The base layer first partition bit stream is not recoded. The base layer second partition bit stream is recoded using a scalable recoder such as FGS. The base layer first partition bit stream and the recoded base layer second partition bit stream are then provided as output along with the FGS enhancement layer bit stream. This provides an ADP+FGS bit stream in accordance with the principles of the invention.

When the input video signal is an uncompressed video, the input video signal is first encoded into an FGS bit stream having an enhancement layer bit rate of R_{E} and having a base layer bit rate of R_{B}. The remaining steps of the second method described above are then carried out.

FIG. 9 illustrates a flowchart showing the steps of a second method of an advantageous embodiment of the present invention described above. In the first step a single layer coded bit stream is received in an FGS transcoder (step 910). The FGS transcoder transcodes the single layer bit stream into an FGS enhancement layer bit stream having an enhancement layer bit rate of R_{E} and into a base layer bit stream having a base layer bit rate of R_{B} (step 920). The base layer first partition bit stream is determined to have non-scalable texture coding (step 930). The base layer second partition bit stream is determined to have scalable texture coding (step 940). The base layer bit stream is then partitioned into a base layer first partition bit stream having a bit rate of R_{B1} and into a base layer second partition bit stream having a bit rate of R_{B2} (step 950). The base layer second partition bit stream is then recoded using a scalable recoder such as FGS (step 960). The base layer first partition bit stream and the recoded base layer second partition bit stream are then provided as output along with the FGS enhancement layer bit stream (step 970).

A third method of an advantageous embodiment of the present invention will now be described. In the third method base layer first partition bit stream has scalable texture coding and the base layer second partition bit stream has scalable texture coding. A single layer coded bit stream is input to an FGS transcoder. The FGS transcoder transcodes the single layer bit stream into an FGS enhancement layer bit stream having an enhancement layer bit rate of R_{E} and into a base layer bit stream having a base layer bit rate of R_{B}. A determination is made that the base layer first partition bit stream has scalable texture coding. A determination is also made that the base layer second partition bit stream has scalable texture coding.

The base layer bit stream is then partitioned into a base layer first partition bit stream having a bit rate of R_{B1} and into a base layer second partition bit stream having a bit rate of R_{B2}. The base layer first partition bit stream is recoded using a scalable recoder such as FGS. The base layer second partition bit stream is also recoded using a scalable recoder such as FGS. The recoded base layer first partition bit stream and the recoded base layer second partition bit stream are then provided as output along with the FGS enhancement layer bit stream. This provides an ADP+FGS bit stream in accordance with the principles of the invention.

When the input video signal is an uncompressed video, the input video signal is first encoded into an FGS bit stream having an enhancement layer bit rate of R_{E} and having a base layer bit rate of R_{B}. The remaining steps of the third method described above are then carried out.

FIG. 10 illustrates a flowchart showing the steps of a third method of an advantageous embodiment of the present invention described above. In the first step a single layer coded bit stream is received in an FGS transcoder (step 1010). The FGS transcoder transcodes the single layer bit stream into an FGS enhancement layer bit stream having an enhancement layer bit rate of R_{E} and into a base layer bit stream having a base layer bit rate of R_{B} (step 1020). The base layer first partition bit stream is determined to have scalable texture coding (step 1030). The base layer second partition bit stream is also determined to have scalable texture coding (step 1040). The base layer bit stream is then partitioned into a base layer first partition bit stream having a bit rate of R_{B1} and into a base layer second partition bit stream having a bit rate of R_{B2} (step 1050). The base layer first partition bit stream and the base layer second partition bit stream are then recoded using a scalable recoder such as FGS (step 1060). The recoded base layer first partition bit stream and the recoded base layer second partition bit stream are then provided as output along with the FGS enhancement layer bit stream (step 1070).

The selection of the optimal bit rates for a particular application is determined by first determining the bit rate range of the application requirements. The bit rate ranges from a minimum bit rate of R_{MIN} to a maximum bit rate of R_{MAX}. As shown in FIG. 3, the minimum bit rate R_{MIN} is equal to the bit rate R_{B1} of base layer first partition 310. In one advantageous embodiment of the invention the bit rate R_{B2} of base layer second partition 320 may be selected to be equal to the bit rate R_{B1} of base layer first partition 310.

The selection of bit rate R_{B2} (the bit rate for base layer second partition 320) affects the rate, complexity, and distortion performance of the resulting ADP+FGS signal. Different optimal bit rates may be selected depending upon the criteria of the application.

FIG. 11 illustrates a flowchart showing the steps of an advantageous method of the present invention for determining an optimal bit rate. The bit rate range (from R_{MIN} to R_{MAX}) for the application is first determined (step 1110). Then a temporal correlation coefficient (TCC) is determined (step 1120). The temporal correlation coefficient (TCC) may be calculated as follows:

$$TCC = \frac{\vert ( {\sum }_{w = 1}^{W} {\sum }_{h = 1}^{H} ( f ( w , h ) - {Ave}_{f} ) ( r ( w , h ) - {Ave}_{r} ) ) \vert}{\sqrt{{\sum }_{w = 1}^{W} {\sum }_{h = 1}^{H} {( f ( w , h ) - {Ave}_{f} )}^{2} {\sum }_{w = 1}^{W} {\sum }_{h = 1}^{H} {( r ( w , h ) - {Ave}_{r} )}^{2}}}$$

where W is the width of the frame/image and H is the height of the frame/image. The letter “f” designates the current frame and the term “Ave_{f}” is an average pixel value of the current frame. The letter “r” designates the motion compensated reference frame for “f” and the term “Aveᵣ” is the average pixel value for the motion compensated reference frame.

After the value of the temporal correlation coefficient (TCC) has been calculated, a determination is made whether the value of the TCC is less than a threshold value (decision step 1130). If the value of the TCC is less than the threshold value, then the bit stream is coded using FGS (step 1140).

If the value of the TCC is greater than the threshold value, then a value for R_{ADP} is determined at which the value of the TCC in the enhancement layer is less than the threshold value (step 1150). The bit stream is then coded using FGS on top of the base layer second partition 320 at the R_{ADP} rate (step 1160). ADP is then performed for the base layer that is coded at the R_{ADP} rate (step 1170). When the partition between base layer first partition 310 and base layer second partition 320 is created, the quality will be optimized for the R_{MIN} bit rate.

A fourth method of an advantageous embodiment of the present invention will now be described. The fourth method is optimized for complexity; The bit rate range (from R_{MIN} to R_{MAX}) for the application is first determined. Then the approximate amount of complexity that can be tolerated by the “high end” device is determined. Then the corresponding base layer second partition bit rate for FGS (i.e., R_{FGS}) is determined. The bit stream is then encoded using the base layer second partition bit rate of R_{FGS}. The base layer using ADP is then coded and the quality of base layer first partition is optimized for the R_{MIN} bit rate.

FIG. 12 illustrates a flowchart showing the steps of the fourth method of an advantageous embodiment of the present invention described above. In the first step the bit rate range (from R_{MIN} to R_{MAX}) for the application is determined (step 1210). The approximate amount of complexity that is tolerable by the “high end” device is determined (step 1220). The corresponding base layer second partition bit rate for FGS is determined (step 1230). The FGS bit stream is coded using the base layer second partition bit rate of R_{FGS} (step 1240). The base layer is coded using ADP and the quality of base layer first partition is optimized for the R_{MIN} bit rate (step 1250).

A fifth method of an advantageous embodiment of the present invention will now be described. The fifth method is optimized for spatial scalability. The bit rate range (from R_{MIN} to R_{MAX}) for the application is first determined. Then the bit rate ranges to be covered by each resolution are determined. The first bit rate range (from R_{MIN} to R_{MAX1}) of resolution X is determined. The second bit rate range (from R_{MAX1} to R_{MAX}) of resolution 4X is then determined. The FGS layer is then coded at bit rate R_{MAX1} at resolution 4X. Then ADP is performed for the base layer with the base layer first partition having a bit rate of R_{MIN} at resolution X.

FIG. 13 illustrates a flowchart showing the steps of a fifth method of an advantageous embodiment of the present invention described above. In the first step the bit rate range (from R_{MIN} to R_{MAX}) for the application is determined (step 1310). The bit rate ranges to be covered by each resolution are determined (step 1320). The first bit rate range (from R_{MIN} to R_{MAX1}) of resolution X is determined (step 1330). The second bit rate range (from R_{MAX1} to R_{MAX}) of resolution 4X is determined (step 1340). The FGS layer is then coded at bit rate R_{MAX1} at resolution 4X (step 1350). ADP is then performed for the base layer with the base layer first partition having a bit rate of R_{MIN} at resolution X (step 1360).

FIG. 14 illustrates a graph that displays the performance of a prior art FGS coded bit stream and two prior art ADP coded bit streams in terms of peak signal to noise ratio at different bit rates. FIG. 14 shows the performance of a single prior art FGS coded bit stream 1410 having a lower base layer bit rate. FIG. 14 also shows the performance of two ADP coded bit streams. The first ADP coded bit stream 1420 has a moderate base layer bit rate. The second ADP coded bit stream 1430 has a high base layer bit rate. The performance of these prior art bit streams is shown so that they can be compared in FIG. 15 with the performance of the combined ADP+FGS coded bit stream of the present invention.

FIG. 15 illustrates a graphic that displays the performance of the ADP+FGS coded bit stream 1510 of the present invention in terms of peak signal to noise ratio at different bit rates. Also shown for comparison are the prior art bit streams from FIG. 14. The performance line for the ADP+FGS coded bit stream 1510 is shown as a dotted line.

As illustrated in FIG. 15, the ADP+FGS bit stream has a base layer coded at three million bits per second (3.0 Mbps). The base layer is partitioned into a base layer first partition having a bit rate of one and one half million bits per second (1.5 Mbps) and a base layer second partition also having a bit rate of one and one half million bits per second (1.5 Mbps). An FGS enhancement layer bit rate of three million bits per second (3.0 Mbps) is shown for the ADP+FGS bit stream. This means that the bit rate range may extend from one and one half million bits per second (1.5 Mbps) to six million bits per second (6.0 Mbps).

The base layer bit rate for FGS increases from 1.5 Mbps to 3.0 Mbps for improved coding efficiency. In the meantime, the upper limit bit rate for the ADP is extended from 3.0 Mbps to 6.0 Mbps. The dotted line 1510 characterizes the rate distortion performance of the ADP+FGS coded bit stream.

FIG. 16 illustrates an exemplary embodiment of a system 1600 which may be used for implementing the principles of the present invention. System 1600 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. System 1600 includes one or more video/image sources 1610, one or more input/output devices 1660, a processor 1620 and a memory 1630. The video/image source(s) 1610 may represent, e.g., a television receiver, a VCR or other video/image storage device. The video/image source(s) 1610 may alternatively represent one or more network connections for receiving video from a server or servers over, e.g., a global computer communications network such as the Internet, a wide area network, a terrestrial broadcast system, a cable network, a satellite network, a wireless network, or a telephone network, as well as portions or combinations of these and other types of networks.

The input/output devices 1660, processor 1620 and memory 1630 may communicate over a communication medium 1650. The communication medium 1650 may represent, e.g., a bus, a communication network, one or more internal connections of a circuit, circuit card or other device, as well as portions and combinations of these and other communication media. Input video data from the source(s) 1610 is processed in accordance with one or more software programs stored in memory 1630 and executed by processor 1620 in order to generate output video/images supplied to a display device 1640.

In a preferred embodiment, the coding and decoding employing the principles of the present invention may be implemented by computer readable code executed by the system. The code may be stored in the memory 1630 or read/downloaded from a memory medium such as a CD-ROM or floppy disk. In other embodiments, hardware circuitry may be used in place of, or in combination with, software instructions to implement the invention. For example, the elements illustrated herein may also be implemented as discrete hardware elements.

While the present invention has been described in detail with respect to certain embodiments thereof, those skilled in the art should understand that they can make various changes, substitutions modifications, alterations, and adaptations in the present invention without departing from the concept and scope of the invention in its broadest form.

1. An apparatus 440 in a digital video transmitter 110 for combining advanced data partitioning and fine granularity scalability in the transmission of digital video signals, said apparatus 440 comprising a partition unit 440 within a base layer encoding unit 410 of a video encoder 400 that partitions a base layer bit stream 310, 320 into a plurality of base layer partition bit streams 310, 320.

2. An apparatus 440 as claimed in claim 1 further comprising a partition point calculation unit 430 having an output coupled to an input of said partition unit 440, wherein said partition point calculation unit 430 provides to said partition unit 440 partition point information for said base layer bit stream 310, 320 to divide said base layer bit stream 310, 320 into a plurality of base layer partition bit streams 310, 320.

3. An apparatus 440 as claimed in claim 1 wherein said plurality of base layer partition bit streams 310, 320 comprise base layer first partition bit stream 310 and base layer second partition bit stream 320.

4. An apparatus 440 as claimed in claim 3 wherein said apparatus 440 further comprises a non-scalable coder unit 444 that encodes one of: said base layer first partition bit stream 310 and said base layer second partition bit stream 320.

5. An apparatus 440 as claimed in claim 3 wherein said apparatus further comprises a scalable coder unit 442 that encodes one of: said base layer first partition bit stream 310 and said base layer second partition bit stream 320.

6. An apparatus 710, 720, 750 in a digital video transmitter 110 for combining advanced data partitioning and fine granularity scalability in the transmission of digital video signals, said apparatus 710, 720, 750 comprising:
FGS transcoder 710, wherein said FGS transcoder 710 is capable of transcoding a single layer bit stream into a base layer bit stream 310, 320 having a base layer bit rate R_{B} and an enhancement layer bit stream 300 having an enhancement layer bit rate R_{E};
variable length decoder unit 720 coupled to said FGS transcoder 710, wherein said variable length decoder 720 is capable receiving said base layer bit stream 310, 320 from said FGS transcoder 710, and decoding variable length codes in said base layer bit stream 310, 320; and
variable length codes buffer 750 coupled to said variable length decoder unit 720, wherein said variable length codes buffer 750 is capable of receiving said variable length codes from said variable length decoder unit 720 and using said variable length codes to partition said base layer bit stream 310, 320 into a plurality of base layer partition bit streams 310, 320.

7. An apparatus 710, 720, 750 as claimed in claim 6 further comprising a partitioning point finder unit 740 having an output coupled to an input of said variable length codes buffer 750, wherein said partitioning point finder unit 740 is capable of calculating and providing to said variable length codes buffer 750 optimal partition point information for dividing a base layer bit stream 310, 320 into said plurality of base layer partition bit streams 310, 320.

8. An apparatus 710, 720, 740, 750 as claimed in claim 7 wherein said partitioning point finder unit 740 is capable of determining an optimal bit rate for a base layer first partition bit stream 310 by comparing a temporal correlation coefficient (TCC) to a threshold value where said temporal correlation coefficient is calculated by the formula:
$$TCC = \frac{\vert ( {\sum }_{w = 1}^{W} {\sum }_{h = 1}^{H} ( f ( w , h ) - {Ave}_{f} ) ( r ( w , h ) - {Ave}_{r} ) ) \vert}{\sqrt{{\sum }_{w = 1}^{W} {\sum }_{h = 1}^{H} {( f ( w , h ) - {Ave}_{f} )}^{2} {\sum }_{w = 1}^{W} {\sum }_{h = 1}^{H} {( r ( w , h ) - {Ave}_{r} )}^{2}}}$$
where W is the width of a frame/image and H is the height of the frame/image, and the letter “f” designates a current frame, and the term “Ave_{f}” is an average pixel value of the current frame, and the letter “r” designates a motion compensated reference frame for “f” and the term “Aveᵣ” is an average pixel value for the motion compensated reference frame.

9. A method for combining advanced data partitioning and fine granularity scalability in the transmission of digital video signals in a digital video transmitter 110, said method comprising the steps of:
partitioning a base layer bit stream 310, 320 into a plurality of base layer partition bit streams 310, 320; and
encoding with a coder unit at least one base layer partition bit stream of said plurality of base layer partition bit streams 310, 320.

10. A method as claimed in claim 9 wherein said coder unit is one of: a scalable coder unit 442 and a non-scalable coder unit 444.

11. A method as claimed in claim 9 further comprising the steps of:
calculating values that represent partition point information in said base layer bit stream 310, 320; and
dividing said base layer bit stream 310, 320 into a plurality of base layer partition bit streams 310, 320 using said values.

12. A method as claimed in claim 9 further comprising the steps of:
determining an optimal bit rate for a base layer first partition bit stream 310 by comparing a temporal correlation coefficient (TCC) to a threshold value where said temporal correlation coefficient is calculated by the formula:
$$TCC = \frac{\vert ( {\sum }_{w = 1}^{W} {\sum }_{h = 1}^{H} ( f ( w , h ) - {Ave}_{f} ) ( r ( w , h ) - {Ave}_{r} ) ) \vert}{\sqrt{{\sum }_{w = 1}^{W} {\sum }_{h = 1}^{H} {( f ( w , h ) - {Ave}_{f} )}^{2} {\sum }_{w = 1}^{W} {\sum }_{h = 1}^{H} {( r ( w , h ) - {Ave}_{r} )}^{2}}}$$
where W is the width of a frame/image and H is the height of the frame/image, and the letter “f” designates a current frame, and the term “Ave_{f}” is an average pixel value of the current frame, and the letter “r” designates a motion compensated reference frame for “f” and the term “Aveᵣ” is an average pixel value for the motion compensated reference frame.

13. A method as claimed in claim 9 further comprising the steps of:
partitioning a base layer bit stream 310, 320 into a base layer first partition bit stream 310 and into a base layer second partition bit stream 320;
determining a bit rate range from a minimum bit rate to a maximum bit rate;
determining an approximate amount of complexity that is tolerable by a video device;
determining a base layer second partition bit rate 320 for fine granularity scalability that corresponds to said approximate amount of complexity;
encoding a fine granularity scalability bit stream using said base layer second partition bit rate 320; and
encoding a base layer bit stream using advanced data partitioning.

14. A method as claimed in claim 9 further comprising the steps of:
partitioning a base layer bit stream 310, 320 into a base layer first partition bit stream 310 and into a base layer second partition bit stream 320;
determining a bit rate range from a minimum bit rate R_{MIN} to a maximum bit rate R_{MAX};
determining a bit rate range to be covered each resolution in a video device;
determining a bit rate range from R_{MIN} to R_{MAX1} for a resolution X;
determining a bit rate range from R_{MAX1} to R_{MAX} for a resolution 4X;
encoding a fine granularity scalability bit stream at bit rate R_{MAX1} at resolution 4X; and
encoding a base layer bit stream using advanced data partitioning with a base layer first partition 310 having a bit rate of R_{MIN} at resolution X.

15. A method as claimed in claim 9 further comprising the steps of:
transcoding a single layer bit stream with an FGS transcoder 710 into base layer bit stream 310, 320 having a base layer bit rate R_{B} and an enhancement layer bit stream 300 having an enhancement layer bit rate R_{E};
sending said base layer bit stream 310, 320 from said FGS transcoder 710 to a variable length encoder 720;
decoding variable length codes in said base layer bit stream 310, 320 with said variable length decoder 720; and
sending said variable length codes from said variable length decoder unit 720 to a variable length codes buffer 750; and
using said variable length codes to partition said base layer bit stream 310, 320 into a plurality of base layer partition bit streams 310, 320.

16. A method as claimed in claim 15 further comprising the steps of:
calculating in a partitioning point finding unit 740 an optimal partition point for dividing said base layer bit stream 310, 320 into a base layer first partition bit stream 310 and a base layer second partition bit stream 320; and
providing said optimal partition point to said variable length codes buffer 750.

17. A digitally encoded video signal generated by a method for combining advanced data partitioning and fine granularity scalability in the transmission of digital video signals, said method comprising the steps of:
partitioning a base layer bit stream 310, 320 into a plurality of base layer partition bit streams 310, 320; and
encoding with a coder unit at least one base layer partition bit streams of said plurality of base layer partition bit streams 310, 320.

18. A digitally encoded video signal as claimed in claim 17 wherein said coder unit is one of: a scalable coder unit 442 and a non-scalable coder unit 444.

19. A digitally encoded video signal as claimed in claim 17 wherein said method further comprises the steps of:
calculating values that represent partition point information in said base layer bit stream 310, 320; and
dividing said base layer bit stream 310, 320 into a plurality of base layer partition bit streams 310, 320 using said values.

20. A digitally encoded video signal as claimed in claim 17 wherein said method further comprises the steps of:
determining an optimal bit rate for a base layer first partition bit stream 310 by comparing a temporal correlation coefficient (TCC) to a threshold value where said temporal correlation coefficient is calculated by the formula:
$$TCC = \frac{\vert ( {\sum }_{w = 1}^{W} {\sum }_{h = 1}^{H} ( f ( w , h ) - {Ave}_{f} ) ( r ( w , h ) - {Ave}_{r} ) ) \vert}{\sqrt{{\sum }_{w = 1}^{W} {\sum }_{h = 1}^{H} {( f ( w , h ) - {Ave}_{f} )}^{2} {\sum }_{w = 1}^{W} {\sum }_{h = 1}^{H} {( r ( w , h ) - {Ave}_{r} )}^{2}}}$$
where W is the width of a frame/image and H is the height of the frame/image, and the letter “f” designates a current frame, and the term “Ave_{f}” is an average pixel value of the current frame, and the letter “r” designates a motion compensated reference frame for “f” and the term “Aveᵣ” is an average pixel value for the motion compensated reference frame.

21. A digitally encoded video signal as claimed in claim 17 wherein said method further comprises the steps of:
partitioning a base layer bit stream 310, 320 into a base layer first partition bit stream 310 and into a base layer second partition bit stream 320;
determining a bit rate range from a minimum bit rate to a maximum bit rate;
determining an approximate amount of complexity that is tolerable by a video device;
determining a base layer second partition bit rate 320 for fine granularity scalability that corresponds to said approximate amount of complexity;
encoding a fine granularity scalability bit stream using said base layer second partition bit rate 320; and
encoding a base layer bit stream using advanced data partitioning.

22. A digitally encoded video signal as claimed in claim 17 wherein said method further comprises the steps of:
partitioning a base layer bit stream 310, 320 into a base layer first partition bit stream 310 and into a base layer second partition bit stream 320;
determining a bit rate range from a minimum bit rate R_{MIN} to a maximum bit rate R_{MAX};
determining a bit rate range to be covered each resolution in a video device;
determining a bit rate range from R_{MIN} to R_{MAX1} for a resolution X;
determining a bit rate range from R_{MAX1} to R_{MAX} for a resolution 4X;
encoding a fine granularity scalability bit stream at bit rate R_{MAX1} at resolution 4X; and
encoding a base layer bit stream using advanced data partitioning with a base layer first partition 310 having a bit rate of R_{MIN} at resolution X.

23. A digitally encoded video signal as claimed in claim 17 wherein said method further comprises the steps of:
transcoding a single layer bit stream with an FGS transcoder 710 into base layer bit stream 310, 320 having a base layer bit rate R_{B} and an enhancement layer bit stream 300 having an enhancement layer bit rate R_{E};
sending said base layer bit stream 310, 320 from said FGS transcoder 710 to a variable length encoder 720;
decoding variable length codes in said base layer bit stream 310, 320 with said variable length decoder 720; and
sending said variable length codes from said variable length decoder unit 720 to a variable length codes buffer 750; and
using said variable length codes to partition said base layer bit stream 310, 320 into a plurality of base layer partition bit streams 310, 320.

24. A digitally encoded video signal as claimed in claim 23 wherein said method further comprises the steps of:
calculating in a partitioning point finding unit 740 an optimal partition point for dividing said base layer bit stream 310, 320 into a base layer first partition bit stream 310 and a base layer second partition bit stream 320; and
providing said optimal partition point to said variable length codes buffer 750.
